(19) United States
(12) Patent Application Publication
(10) Pub. No.: US 2002/0005301 A1
(43) Pub. Date: Jan. 17, 2002

(54) Removable top plate for commercial food scales

(76) Inventor: David A. Rehm, Bensalem, PA (US)

Correspondence Address: Richard C. Ltman, LITMAN LAW OFFICES, LTD., P.O. Box 15035, Arlington, VA, 22215, US

(21) Appl. No.: 09/847,433

(22) Filed: May 3, 2001

Related U.S. Application Data
(60) Provisional application No. 60/217,687, filed on Jul. 12, 2000.

(51) Int. Cl. G01G 21/00; G01G 21/28

(52) U.S. Cl. 177/238

(57) ABSTRACT

A removable color coded top plate for a commercial food service scale to prevent cross-contamination from weighing different raw foods. A rectangular top plate has a specially shaped slot underneath which removably engages an L-shaped connector rod held vertically on a scale having a weight indicator. The top plate can be made of transparent plastic. A color coding of top plates consisting of red for raw meat, blue for seafood, yellow for poultry, green for produce, tan for cooked meat, and clear for miscellaneous food can be employed. The color-coded top plate can be readily removed when weighing a different food, e.g., chicken after meat, to ensure no cross-contamination between these raw and cooked foods.

### CROSS-REFERENCE TO RELATED APPLICATION

This application claims the benefit of U.S. Provisional Patent Application Serial No. 60/217,687, filed Jul. 12, 2000.

### BACKGROUND OF THE INVENTION

1. Field of the Invention

The present invention relates generally to weighing scales. More specifically, the invention is a removable color coded top plate for a food service scale to prevent cross-contamination from weighing different raw foods.

2. Description of Related Art

The related art of interest describes various scales with various top plates, but none discloses the present invention. There is a need for avoiding contamination when weighing different foods in commercial use. The solution is based on color coded and readily removable top weighing plates. The related art will be discussed in the order of relevance to the present invention.

U.S. Pat. No. 4,619,337 issued on Oct. 28, 1986, to Lothar Behrend et al. describes an electric balance with the balance scale having a conical support. The balance scale is distinguishable for lacking a separate support for the balance scale and any color identification.

U.S. Pat. No. 5,033,562 issued on Jul. 23, 1991, to Richard E. Cone describes a quick release weigh plate for a checkout weighing device comprising a plastic apertured cover member and a windowed aluminum top plate member combination. The weigh plate is distinguishable for its two-piece construction and the lack of color coding.

U.S. Pat. No. 5,345,043 issued on Sep. 6, 1994, to Paul Luechinger et al. describes a weighing scale having a removable top cover wall to enable cleaning. The scale is distinguishable for lacking a removable weighing pan and color coding.

U.S. Pat. No. 993,005 issued on May 23, 1911, to Elmer E. Weck describes a weighing scale comprising a platform fastened by a screw to a bent standard having a triangular cross-section. The standard is affixed to two levers. The scale is distinguishable for its fixed platform and lack of color coding.

U.S. Pat. No. 359,921 issued on Jul. 4, 1995, to Alexander B. Robertson et al. describes a portable scale with a cover. The scale portion is separated from the weight indicator portion. A detachable weighing plate is not discernable and color coding is absent.

U.S. Pat. No. 3,811,523 issued on May 21, 1974, to Kert E. Artwick et al. describes a bathroom scale comprising a transparent plastic cover mounted on a platform with the underside painted a desired decorator color except for the circular weight indicator scale. The cover is attached to the platform by foamed strips at each corner. The scale is distinguishable for its lack of a standard support and color coding.

U.S. Pat. No. 3,828,870 issued on Aug. 13, 1974, to Josef Schwarz describes a scale having a housing and a weighing platform on top having a movable balance arm. The platform is removably connected with the arm. The scale is distinguishable for its structurally different arm and the lack of color coding.

U.S. Pat. No. 4,055,141 issued on Oct. 25, 1977, to Douglas M. Homs describes a transparent dial and outer transparent cover for a scale with zero-setting adjustment. The cover can be changed for indication of postal mail information and the like, but requires a template. The cover is supported by a staff. The scale is distinguishable for its staff support and the lack of color coding.

U.S. Pat. No. 4,363,371 issued on Dec. 14, 1982, to William Y. Hutchinson describes a changeable baby weighing scale with a column supporting the readout mechanism. The scale is distinguishable for its lack of a post for the baby weighing tray and color coding.

U.S. Pat. No. 5,641,947 issued on Jun. 24, 1997, to Michael C. Riddle describes a receptacle removably attached to a weighing scale for disposal of medical waste in plastic bags. A box-shaped container comprises a cover, a body and a base. The scale transmits the weight to a digital readout display located on the body. The device is distinguishable for lacking a connection between the base and the scale and color coding.

U.K. Patent Application No. 2,028,520 A published on Mar. 5, 1990, for Ernst Kuhnle describes an electrical price-calculating weighing device comprising a weighing part (tray) with a spirit level connected to the indicator part at one end by a clip. The device is distinguishable for its clip attachment and the lack of color coding.

U.K. Patent Application No. 1,323,856 published on Jul. 18, 1973, for Hobart Manufacturing Co. describes a weighing scale with an improved dashpot. The scale comprises a windowed housing upright in the rear of a rectangular base. A weighing platter is supported by four posts to the base. The scale is distinguishable for its four base posts and the lack of color coding of the platter.

Canadian Patent No. 1,199,346 issued on Jan. 11, 1986, to Robert L. Boyles describes a household weighing scale utilizing a multi-string weighing system stressed in tension and vibrated at its resonant frequency for determining the weight on the scale. The scale comprises two square parts with the platform member with its digital display integrated and above a base member. The scale is distinguishable for its lack of color coding and removable platform member.

None of the above inventions and patents, taken either singly or in combination, is seen to describe the instant invention as claimed.

### SUMMARY OF THE INVENTION

The present invention is directed to a removable color coded top plate for a commercial food service scale to prevent cross-contamination from weighing different raw or cooked foods. A rectangular top plate has a specially shaped slot underneath which removably engages an L-shaped connector rod held vertically on a scale having a weight indicator. The top plate can be made of transparent plastic. A color coding of top plates consisting of red for raw meat, blue for seafood, yellow for poultry, green for produce, tan for cooked meat, and clear for miscellaneous food can be employed. The color-coded top plate can be readily removed when weighing a different food, e.g., chicken after meat, to ensure no cross-contamination between these raw and cooked foods.

Accordingly, it is a principal object of the invention to provide a food weighing scale for prevention of cross contamination in weighing different raw or cooked foods.

It is another object of the invention to provide a food weighing scale with a removable top plate.

It is a further object of the invention to provide a food weighing scale with a color-coded top plate.

Still another object of the invention is to provide a food weighing scale, wherein the different colors of the top plate indicate different foods.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an exploded perspective side view of a removable top plate for a commercial food scale according to the present invention.

FIG. 2 is an exploded rear view of the removable top plate for a commercial food scale according to the present invention.

FIG. 3 is a bottom view of the removable top plate.

Similar reference characters denote corresponding features consistently throughout the attached drawings.

### DETAILED DESCRIPTION OF THE PREFERRED EMBODIMENTS

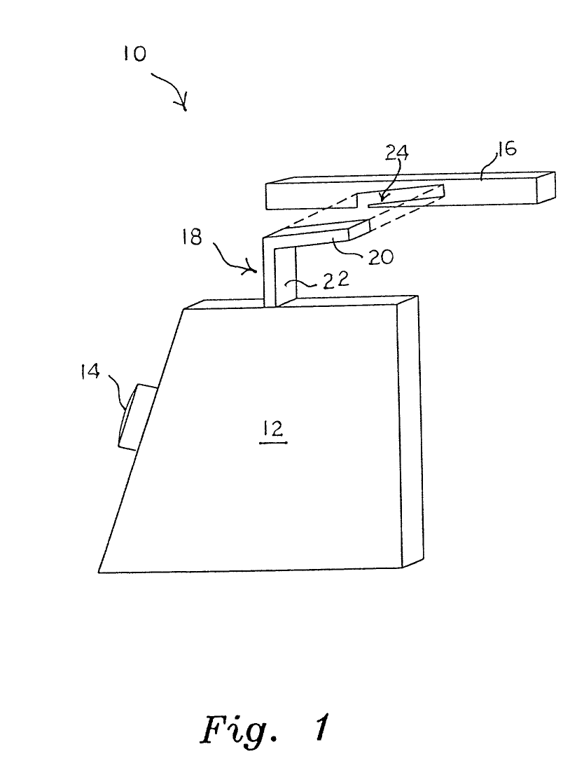

The present invention 10 is illustrated in exploded version in FIG. 1 as a conventional scale base 12 having a weight indicator 14 and a planar top plate 16 supported by an L-shaped connector 18. The connector 18 has a top leg 20 angled slightly more than 90° from the upright leg 22 for fitting into the slot 24. The purpose of the tilted up top leg 20 is to compensate for the weight of the top plate 16.

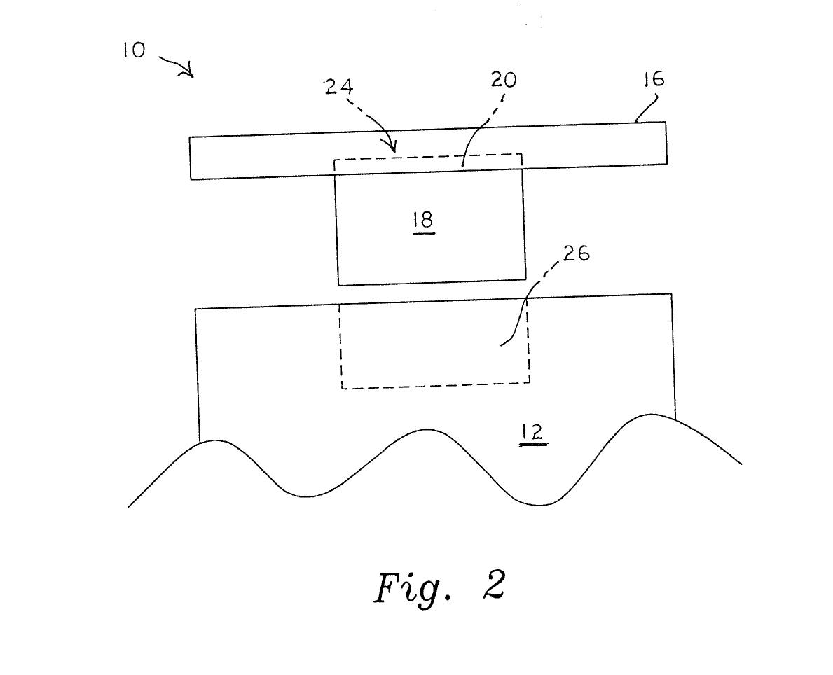

In FIG. 2, the invention 10 is viewed in exploded version from the rear. The top plate 16 is now connected to the connector 18 with its top leg 20 inserted in the slot 24 of the top plate 16. The upright leg 22 will be inserted in slot 26 of the scale base 12.

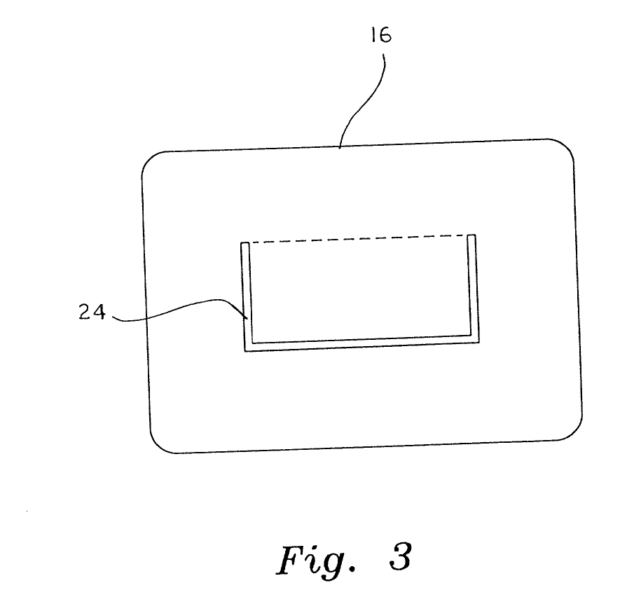

In FIG. 3, the bottom view of the top plate 16 is depicted to show the U-shaped slot 24.

It is a vital part of the present invention to utilize a transparent top plate 16 having a color coding consisting of red for raw meat, yellow for poultry, blue for seafood, green for produce, tan for cooked meat, and clear for miscellaneous food. In this manner, the food dispenser and weigher can utilize the correct top plate 16 and prevent contamination of any food being weighed.

The top plate 16 can be readily disconnected from the conventional scale base 12 for cleaning after use, and another clean top plate 16 for another raw food product can be readily inserted in the scale base 12. This interchangeable plate property results in also economizing on the cost of extra scales.

It is to be understood that the present invention is not limited to the sole embodiment described above, but encompasses any and all embodiments within the scope of the following claims.

I claim:

1. A removable top plate for a commercial food scale:
a transparent rectangular top plate having a color coding consisting of red for raw meat, blue for seafood, yellow for poultry, green for produce, tan for cooked meat, and clear for miscellaneous food;
said top plate having a U-shaped slot on its bottom surface; and
an L-shaped connector element having an upright leg and a top leg positioned slightly above the horizontal for insertion into the slot in said top plate.

2. The removable top plate according to claim 1, wherein the top plate is made of transparent plastic.

3. A method of utilizing a removable top plate for a commercial food scale and for prevention of raw food contamination:
providing a transparent rectangular top plate having a color coding consisting of red for raw meat, blue for seafood, yellow for poultry, green for produce, tan for cooked meat, and clear for miscellaneous food;
said top plate having a U-shaped slot on its bottom surface and an L-shaped connector element having an upright leg and a top leg positioned slightly above the horizontal for insertion into the slot in said top plate;
removing and washing the soiled top plate after weighing one type of food; and
inserting another removable top plate color coded for the next different type food to be weighed to prevent cross-contamination.

4. The removable top plate according to claim 3, wherein the top plate is made of transparent plastic.
